(19) United States
(12) Patent Application Publication
(10) Pub. No.: US 2002/0091615 A1
(43) Pub. Date: Jul. 11, 2002

(54) Transaction communication system

(76) Inventor: Joseph M. Salvani, Vero Beach, FL (US)

Correspondence Address: BAZERMAN & DRANGEL, P.C., 60 EAST 42ND STREET, SUITE 820, NEW YORK, NY, 10165, US

(21) Appl. No.: 09/757,337

(22) Filed: Jan. 9, 2001

(51) Int. Cl. G06F 17/60

(52) U.S. Cl. 705/37

(57) ABSTRACT

The invention is a front-end brokerage service application, in a format, such as a java or direct X applets, embedded code or other internet applications, that can be imbedded into third party web page, HTML or other rich media enabled e-mail, web enabled desktop applications or other forms of rich media which allow internet communication, i.e., a document in any format which can be read in a web browser. The application communicates through the third party's server to a broker/dealer which provides trading transaction support and streaming real time and delayed financial data feeds. A middleware layer provides a transaction routing from the front end application to an appropriate transaction system. As an alternative to a web page, the application may be embedded in a HTML or other rich media enabled e-mail or in a program, such as a personal finance and spread sheet, which provides for interaction with the internet. In each case, the present invention merely acts as a conduit between the trader and the dealer/broker. It does not make any trades itself nor preform any matching between buyers and sellers to make the trade.

### BACKGROUND OF THE INVENTION

1. Field of the Invention

The present invention relates generally to on-line trading of stocks, securities, commodities, debts and other electronic commercial transactions through a broker/dealer or electronic exchange device utilizing the internet and more specifically to a front end application which allow individuals to so trade through an application such as Java or Direct X applets, embedded code or other internet applications which is be embedded in third party web pages, HTML enabled e-mail, desktop applications or other forms of rich media which allow internet communication.

2. Description of the Related Art

The evolution of the securities market from under negotiation on street comers to internet transactions has been progressing at an ever increasing pace. Currently, shares can be bought or sold on-line through broker/dealers. On-line trading is conducted by an investor receiving market information and placing market orders through his personal computer. The transaction is directly between the investor and the broker/dealer through a broker/dealer's proprietary program.

Usually that program is accessed over the internet as a web page in a browser. In such transactions, the transaction is conducted through the broker/dealer's web page by a trader who has entered the internet address of the broker/dealer in his web browser or who has linked to the broker/dealer from another web page. Where the trader uses more than one online broker/dealer, he must call up each broker/dealer's web site separately.

If entry is through a link on a third parties web page, the link was either placed to enhance the third parties cite or as part of an advertisement. If an advertisement, the owner of third party web page would usually receive either a flat fee or a fee based on the number of times the link is used (i.e,.CPMs). If not an advertisement, the adding of a link is simply driven by the web page owners perceptions of his audience desires and needs. In most cases, particularly for low traffic sites, the incentive to include a link is relatively insubstantial.

### SUMMARY OF THE INVENTION

The present invention provides traders with network access and communications transmissions links. Through these links, traders are able to transmit their trade orders to broker/dealers, which then effectuate the transactions and issue confirmations and statements. The invention is a front-end brokerage service application, in any format, such as a java or direct X applets, embedded code or other internet applications, that can be imbedded into third party web page, HTML or other rich media enabled e-mail, web enabled desktop applications or other forms of rich media which allow internet communication, i.e., a document in any format which can be read in a web browser. For the purposes of this application, such document will be designated as a “web document.” The application communicates through the third party's server to a broker/dealer which provides trading transaction support and streaming real time and delayed financial data feeds. A middleware layer provides a transaction routing from the front end application to an appropriate transaction system. In other words, the present invention consists of an application embedded in third party web document which allows traders on-line to communicate with selected broker/dealers, through the application rather than through a broker/dealer's web page. As an alternative to a web page, the application may be embedded in a HTML or other rich media enabled e-mail or in a program, such as a personal finance and spread sheet, which provides for interaction with the internet. In each case, the present invention merely acts as a conduit between the trader and the dealer/broker. It does not make any trades itself nor perform any matching between buyers and sellers to make the trade.

By this method, an on-line trader may be given the option of researching the market, selecting one from a number of broker/dealers and transmitting a transaction to a selected broker/dealer, from the same web page or from an e-mail forwarding information concerning the shares. The third party web server acts as an intermediary and obtains information sufficient to allow it to bill the selected broker/dealer for its information transmittal services for the orders transmitted from the applets through the third parties server. This would act as a strong incentive for third parties to incorporate the applets in their web page. The broker/dealer would charge its normal brokerage fees for the activities requested and could also pass along the information transmittal fees to the traders.

The system would open to any broker/dealer firm that complies with a specific set of network protocols or uses one of a set of approved clearing firms. The front end embedded application can be ran with the look and feel of the user's brokerage firm including bearing the broker/dealer's logo and trading command set. The application provides for a selection of participating broker/dealers to accommodate individuals who wish to engage a new broker/dealer or who use multiple broker/dealers. The third party web page owner selects the broker/dealers available on his web page. This allows the web page owner to enter into agreements with specific broker/dealers based on its own selection criteria and terms. Traders can conduct trades, view financial information and do the other activities they would typically do on a traditional on-line broker/dealer web site. Thus, any broker/dealer can deliver their on-line trading system to their customers through a large number of third party non-broker/dealer web sites. The third party web sites are able to retain customer attention at their own sites while generating revenues for the information transmittal services on an executable order basis.

The present invention allows compensation arrangements designed to enable broker/dealers to service investors more efficiently and at lower cost. The present invention is the communication conduit between a trader and one of a number of broker/dealers which then make the matches and effectuate the trades trough their own systems. With fewer fixed or arbitrary costs, broker/dealers would be able to service traders from a broader mix of online services. Traders would gain greater and more convenient access to the securities markets and their broker/dealers through a variety of online services. The present invention helps assure economically efficient transactions in securities and the efficiency of order entry and execution process.

### BRIEF DESCRIPTION OF THE DRAWINGS

FIG. 1 is a screen shot of a web page with an embedded trading display in accordance with the present invention;

FIG. 2 is a diagram showing the interconnection of an embedded trading display to the web server host in accordance with the present invention;

FIG. 3 is a diagram showing the interconnection of multiple broker/dealers with multiple traders through the present invention;

FIG. 4 is a flow diagram of the sign-in procedures; in accordance with the present invention

FIG. 5 is a partial screen shot showing the entry banner for the sign-in to the for a broker/dealer in accordance with the present invention;

FIG. 6 is a partial screen shot showing the registration form in accordance with the present invention;

FIG. 7 is a partial screen shot showing the sign-in form for the system in accordance with the present invention;

FIG. 8 is a partial screen shot showing the broker/dealer selection form in accordance with the present invention;

FIG. 9 is a partial screen shot showing the sign-in form for an individual broker/dealer in accordance with the present invention;

FIG. 10 is a partial screen shot showing the trading display for an individual broker/dealer in accordance with the present invention; and

FIG. 11 is a partial screen shot showing the trading display with the accounts and order displays open.

### DETAILED DESCRIPTION OF THE PREFERRED EMBODIMENTS

The average online trader first does his research at a number of sites, makes market decisions and then goes to the web page of his broker/dealer. The present invention recognizes that it would be an advantage to traders to have a readily available broker/dealer option on diverse third party web pages, including web pages where the trader would do his research, read annual reports of companies, read product catalogues, or other sites of use to the trader.

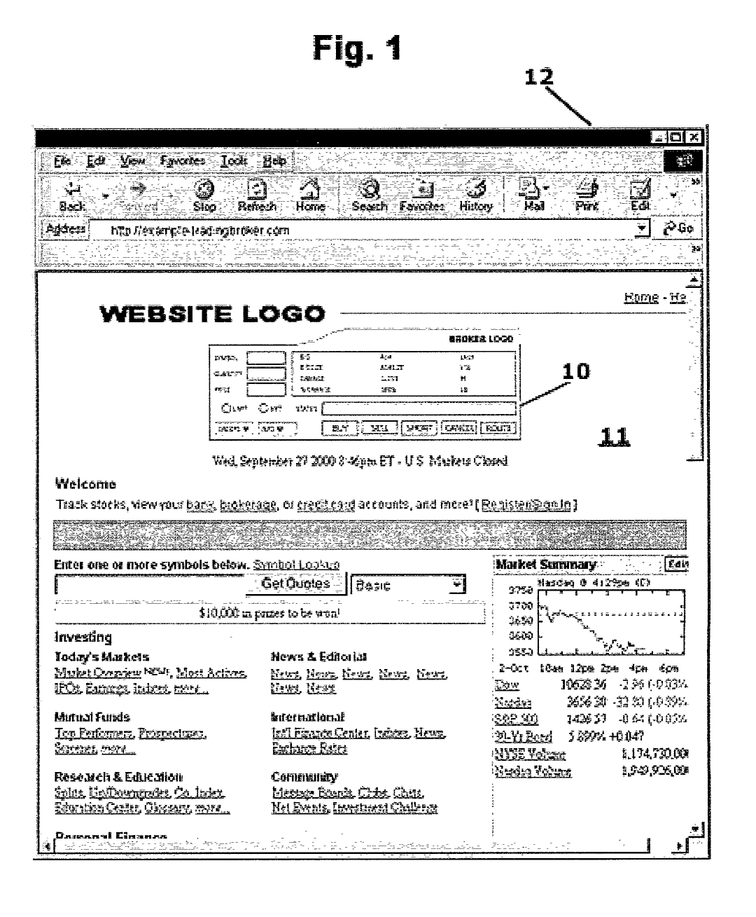

FIG. 1 is a screen shot of a browser 12 displaying a web page 11. Web page 11 is a typical research page on which a trader may research items such as market summaries, individual shares and news events that might affect share price. A trading display 10 in accordance with the present invention is shown in an empty location on the web page 11.

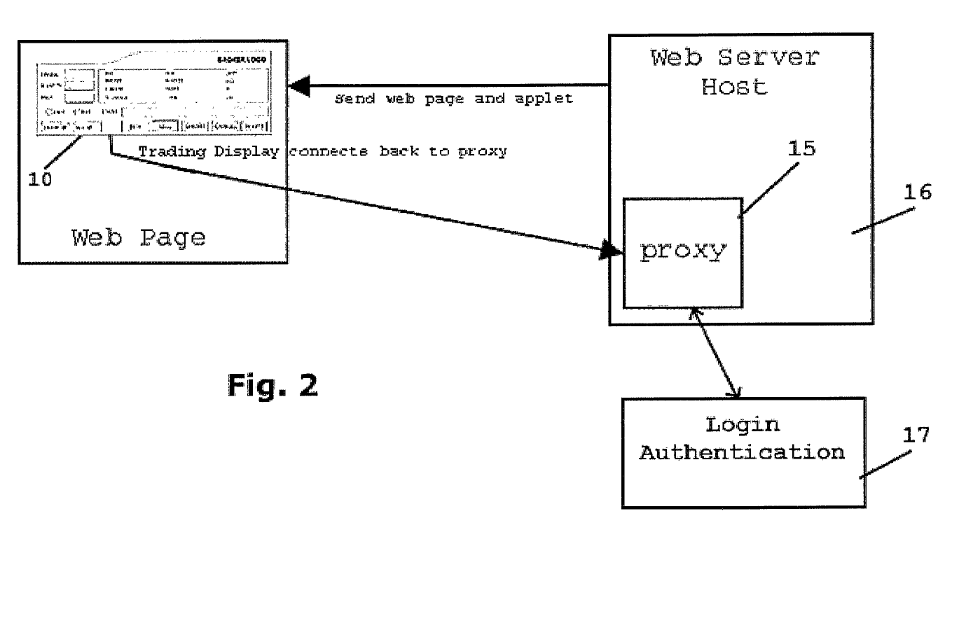

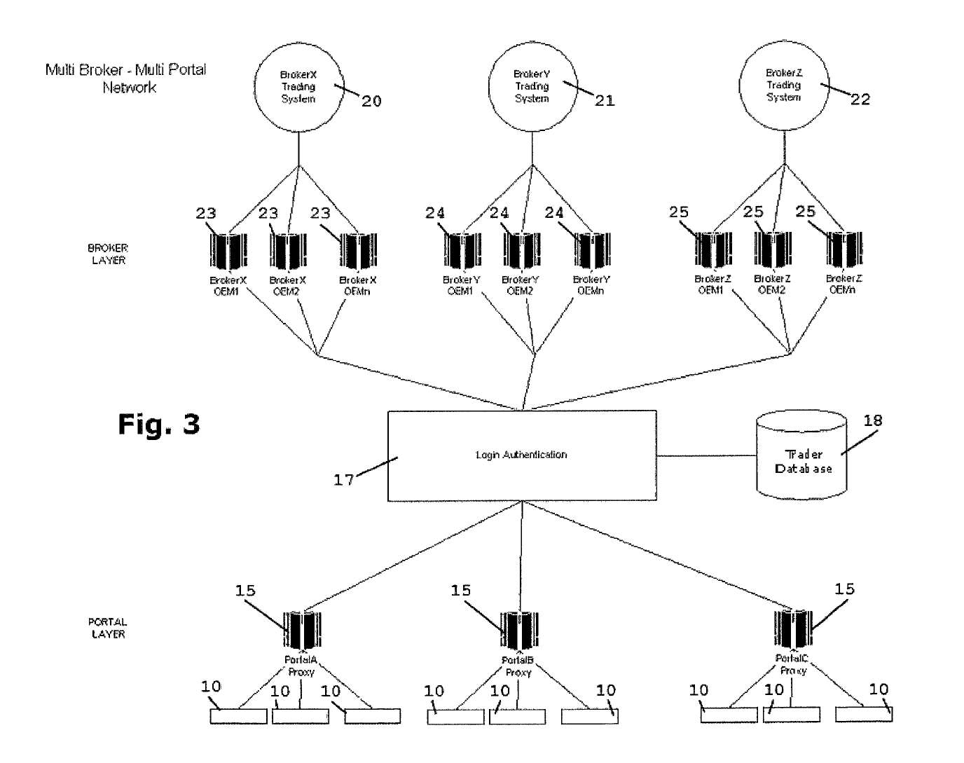

As seen most clearly in FIG. 2, the web page 11 is supplied by a web server host 16 which sends HTML code and various applications or applets, including the application for the trading display 10, to form the web page 11 on the trader's web browser 12. The trading display 10 is in communication with a proxy 15 through the server host 16. The proxy 15, in turn, is in communication with a login authentication means 17 to allow entry and interconnection with various broker/dealer's trading systems as seen more clearly in FIG. 3.

FIG. 3 shows the interconnection of multiple trading displays 10 through their respective proxies 15 to their selected broker/dealers 20-22. The traders through their trading displays 10 communicate with login authentication means 17 through proxies 15. The login authentication means 17 is in communication with the trader database 18 which contains information about each registered trader. When a trader has logged on through his trading display 10 and is admitted by login authentication means 17, it is then connected to the broker/dealer trading system 20, 21 and 22 the trader has selected through the selected broker/dealer's server 23, 24 or 25, as the case may be.

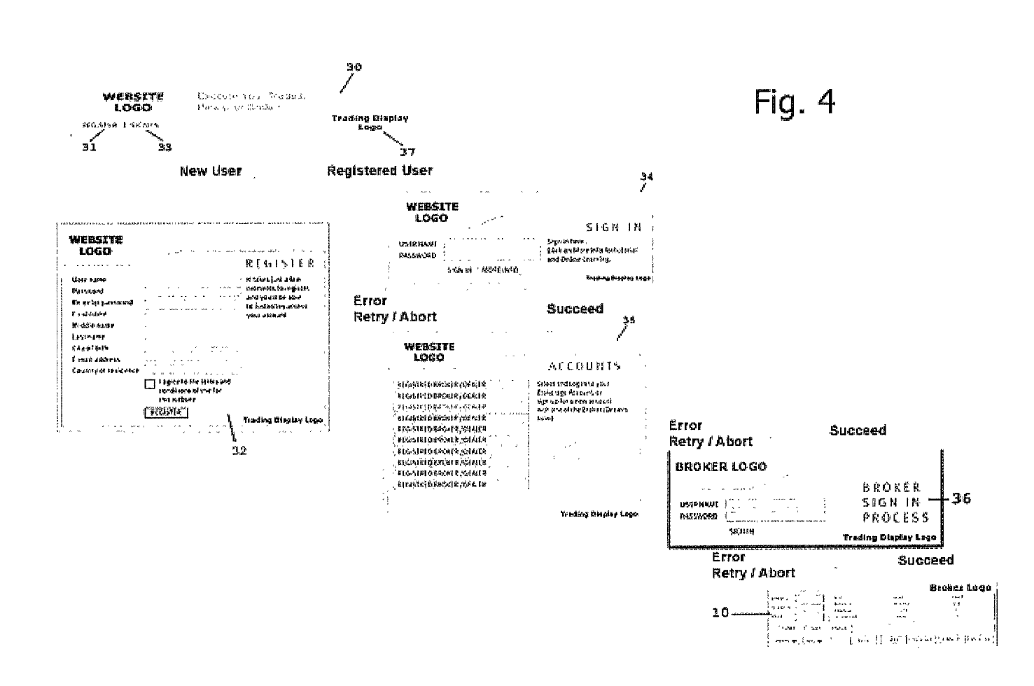

As seen most clearly in the illustrated flow diagram of FIG. 4, when a trader is initially presented with a web page 11 containing a trading display 10 in accordance with the present invention, he simply sees a register/sign-in display 30. If he has not used the system before, he can click on register button 31 and be presented with register form 32. On the other hand, if he is a registered user, he can click on the sign-in button 33 and be presented with the system sign-in form 34. If there is an error either in his user name or password, he is allowed to retry. At the customer's option, after a certain number of trials, the attempted entry into the system may be aborted as a security measure. If the trader successfully logs into the system, he is presented with broker/dealers entry page 35 which allows him to select the dealer that he desires to conduct the trade. Upon selection of a broker/dealer in which he already has an account, he is presented with the broker/dealer's sign-in form 36. Upon successful completion of that form, including entry of the password, he is presented the trading display 10 where which to receive information on the market and to conduct trades. If he has not previously registered with the broker/dealer, the trader is presented with the broker/dealer's application form (not shown).

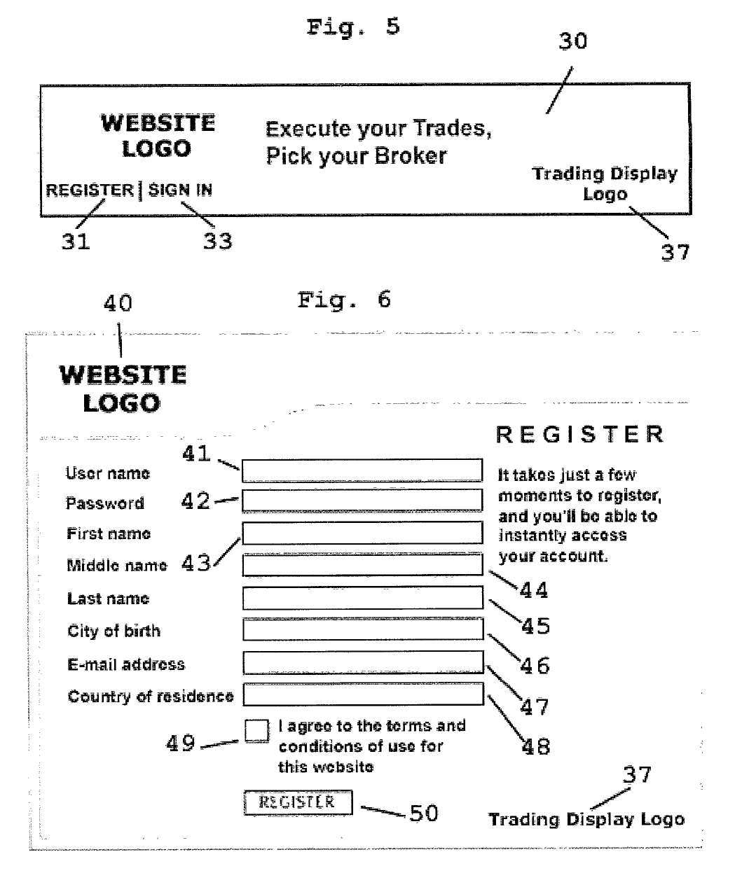

As seen more specifically in FIG. 5, the initial entry point to the system 30 would normally be in the form of a banner, hyperlink or similar display which might contain an advertisement for traders to register 31 as well as an entry point 33 for registered users. It could bear the web page logo 40, the trading display logo 37 or such other logo as the web page owner may desire, such as the logos of all of the broker/dealers available at that web page.

FIG. 6 is the registration form for new users of the system. It contains text boxes 41 through 48 for entry of information such as user name, proposed password, first name, middle name and last name of the trader, e-mail address and country of residence. In addition, information such as city of birth and/or mother's maiden name may be entered at 46 to allow for further identification of the trader. The registration form 32 may also contain terms and conditions of enrollment 49 or a button to allow viewing of such terms (not shown). Once the form has been completed, the trader can simply click on the registration button 50 to submit the information.

As seen in FIG. 7, once registered, the trader may enter the system by using the system sign-in form 34. The trader enters the user name at text box 51 and password at text box 52 and then submits the sign in by clicking on the sign-in button 53. The trader may find out more about the system by clicking on button 54.

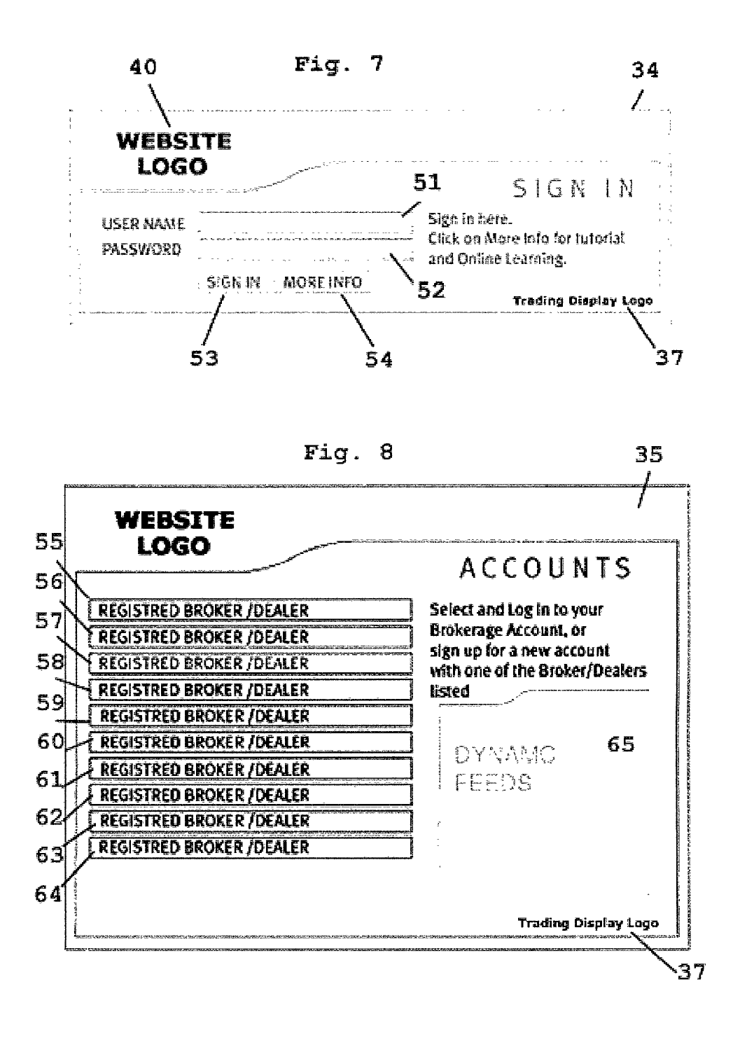

Once entering the system, the trader is presented with a broker/dealers entry page 35, as seen in FIG. 8. The broker/dealers entry page 35 contains a list of registered broker/dealers 55-64 available on that web page 11 through the trading display 10. In addition, there may be a dynamic feed 65 which displays information such as ticker tape information, articles, headlines, or relevant announcements or advertisements for particular broker/dealers. The trader highlights the broker/dealer with which he wants to deal by clicking on the appropriate entry 55-64.

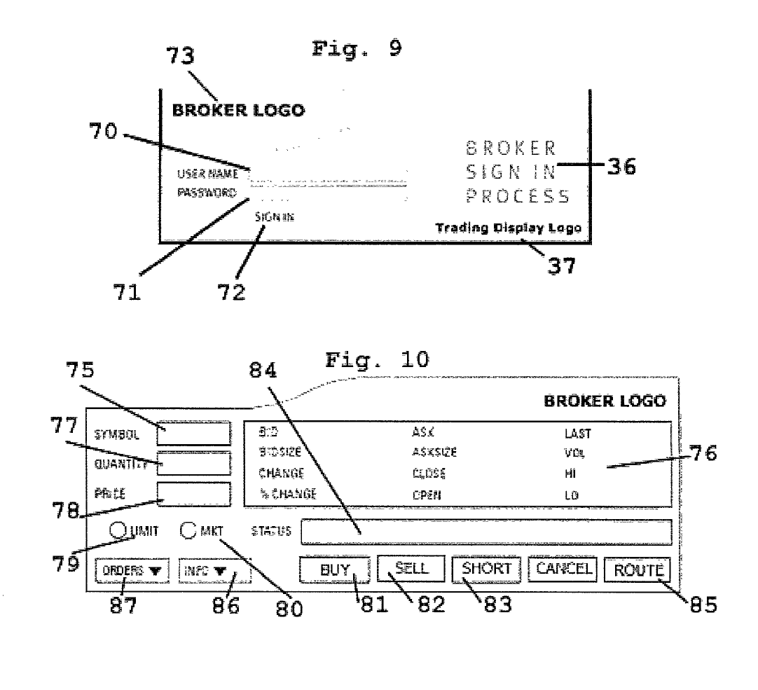

As seen in FIG. 9, upon the trader selecting a particular broker/dealer, the broker/dealer signing form 36 is displayed allowing the trader to enter his user name in text box 70 and password in text box 71. The entry form may contain the broker/dealer's logo 73. Once entered the trader simply clicks the sign-on button 72 and the trading display 10 will appear on the web page 11 as seen, for example, in FIG. 1.

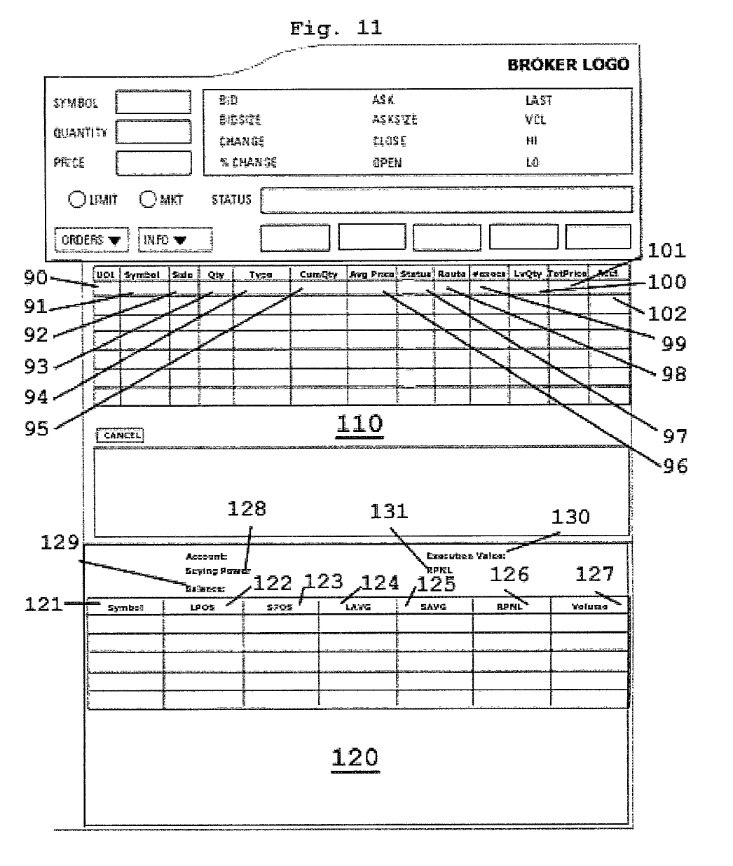

As seen in FIG. 10, the trading display 10 contains a text box 75 for entering a stock symbol. When the stock symbol is entered, information concerning the current market for that stock appears in box 76. If, after review of this information and research done on the web page, the trader desires to purchase or sell a quantity of this stock, he can enter the amount he wishes to be traded in box 77 and, if appropriate, a price for such transaction in text box 78. The trader can indicate whether he desires to place a limit order by clicking on limit check box 79. If the trader wishes the transaction to occur at current market price, the trader clicks on market box 80. Since boxes 79 and 80 are alternatives, only one can be clicked at a time. To conduct a trade, he clicks on one of three buttons, buy 81, sell 82 or short 83, which will send the order through the system to the selected broker/dealer to conduct the transaction. The status of the transaction appears in display box 84. The messages to be included are determined by the broker/dealer. For example, when the order is completed, the words “order filled” or “executed” might appear in that box. Other possible messages include: order pending, fails market risk, or order filled. Box 85 is available for use, for trading instructions made available by the particular broker dealer. For example, box 85 may be a drop down menu of particular ECNs or exchanges for broker/dealers which allow their traders to select where the order is to be placed.

In addition, there is an accounts button 86 and an order button 87. As seen most clearly in FIG. 11, when the order button is clicked an order window 110 is opened showing the current status of current orders, i.e., any pending orders and any transactions recently consummated. The displayed information may include User Order Identifier (UOI) 90, the stock symbol 91, side of the transaction (buy, sell or short) 92, quantity 93, type of order (market or limit) 94, cumulative quantity 95, average price 96, status of the transaction 97, route 98, number of execution 99, amount still left to execute (LvQty) 100, total price 101, account 102 and other indicia as determined by the broker/dealer.

The accounts button opens an account window 120 showing the current status of all of the trader's accounts with this broker/dealer. It includes the stock symbol for all shares traded through the account 121, long position (LPOS) 122, short position (SPOS) 123, long average position (LAVG) 124, savings 125, realized net profit or loss (RPNL) 126, volume 127. Information as to the state of the account as a whole may also be provided, including buying power 128, balance 129, execution value 130 and total realized profit or loss 131.

Each aspect of the present invention is totally customizable. The use of both the web pages and the individual broker/dealers logos may be added to any of the dialogue boxes used. The trading display 10 may have its layouts and available commands and displays varied from broker/dealer to broker/dealer at the broker/dealer's option. Thus, some broker/dealers may allow different forms of trading or provide for different display as to current market conditions or provide technical information concerning any particular stock in the trading display 10.

As a result, this system allows a trader to call up his broker/dealer while on any third party web page. Equally, this allows web page owners to enter into agreements with specific broker/dealers to allow them to appear on their web page through the use of the trading display of the current invention. Since the execution instruction passes through the page owner's server, the trader can obtain information as to each order passing through the trading display 10 from the trader to the broker/dealer's system for execution. This allows the web page owner to charge an information transmittal services fee based on the number of executable orders actually passing through trading display 10 on the web page 11. This acts both as an incentive for having the trading display available on any particular web page and allows the web page owner to select broker/dealers to the web page and obtain information transmittal services compensation for such display.

The trading display may also be made available in any other environment where access to the internet may be obtained. For example, most e-mail is now HTML enabled. Thus along with an e-mail concerning a stock can come the applet of the present invention. The e-mail would display the register/sign-in display 30 and the trading display 10 could be called up as discussed above using the senders server or other server address contained in the applet. Equally, desktop software such as spreadsheets are allowing internet communication. Thus, the application of the preset invention can be seamlessly integrated into such applications in a like manner.

While the present invention has been discussed in terms of securities, the invention is equally applicable to many other financial instruments and commercial transactions including commodities, debt, airline tickets, lottery tickets, currencies and other transactions involving the e-commerce purchase and sale of goods and services. For example, it could be used to research and purchase commodities through commodity broker/dealers or physical commodity exchanges or other sources. Equally, while the above description speaks in terms of broker/dealers as effectuating security trades, the applet of the present invention may communicate directly with electronic exchanges such as ECNs.

It is understood that the present embodiment described above is to be considered as illustrative and not restrictive. It will be obvious to those skilled in the art to make various changes, alterations and modifications to the invention described herein. To the extent that these variations, modifications and alterations depart from the scope and spirit of the appended claims, they are intended to be encompassed therein.

I claim:

1. A method for allowing a trader access in an application that allows access to information via the internet document to multiple alternative sources for commercial transactions including the steps of:
providing in a web document, an application which provides communication over a network;
allowing the trader to identify himself through said application;
confirming that the trader is authorized to trade using the application;
selecting through said application one of multiple sources for said commercial transactions;
confirming that the trader is authorized to conduct trades with the selected source; and
connecting the user to the selected source through said network.

2. A method according to claim 1, wherein the application is in communication with an application server.

3. A method according to claim 2, wherein the application server also supplies the web document and is in communication with the web document and the application through the internet.

4. A method according to claim 2, wherein said application server communicates with a log-in authentication server which confirms that the trader is allowed to use the application, said log-in authentication server also being in communication with application servers for other traders.

5. A method according to claim 1, wherein the trader conducts trades in said commercial transactions through said source using the application.

6. A method according to claim 5, wherein the trades are in commercial instruments and the sources are broker/dealers.

7. A method according to claim 5, wherein the trades are in stocks and the sources are broker/dealers and/or electronic exchanges.

8. A method according to claim 5, wherein the trades are in commodity futures and the sources are broker/dealers.

9. A method according to claim 5, wherein the trades are in goods and the sources are vendors of such goods.

10. A method according to claim 5, wherein the trades are in services and the sources are vendors of such services.

11. A method according to claim 1, wherein the web document is displayed in a web browser.

12. A method according to claim 1, wherein the web document is in an e-mail.

13. A method according to claim 1, wherein the web document is embedded in a desktop application.

14. A system for the trading in commercial transactions over the internet comprising:
a web document;
means embedded in such web document for connecting with a server;
means for displaying the web document;
means for obtaining authorizations for a trader to communicate with multiple broker/dealers through said server;
means for selecting one of a multiple of broker/dealers in said commercial transaction provided through the means embedded in such web document;
means for authorizing the trader to deal with the selected broker/dealer; and
means for conducting commercial transactions from said original communication means to said selected broker through said server.

15. A system according to claim 14, wherein commercial transactions are conducted through brokers.

16. A system according to claim 14, wherein commercial transactions are conducted through electronic exchanges.

17. A system according to claim 14, wherein commercial transactions are conducted through vendors.

18. A system according to claim 14, wherein the means embedded in such web document for connecting with a server, communicates with the server through the internet.

19. A system according to claim 18, wherein the means for obtaining authorizations for a trader to communicate with multiple broker/dealers through said server is a log-in authentication server which confirms that the trader is allowed entry to the system, said log-in authentication server also being in communication with servers for other traders.

20. A system according to claim 14, wherein the web document is displayed in a web browser.

21. A system according to claim 14, wherein the web document is embedded in an e-mail.

22. A system according to claim 14, wherein the web document is embedded in a desktop application.

23. A system for the trading in commercial transactions through brokers over the internet comprising:
a web document;
means embedded in such web document for connecting with a server;
means for displaying an web document;
means for selecting one of a multiple of broker/dealers in said commercial transaction provided through the means embedded in such Web document; and
means for conducting commercial transactions from said original communication means to said selected broker through said server.

24. A system according to claim 23, wherein the means embedded in such web document for connecting with a server, communicates with the server through the internet.

25. A system according to claim 23, wherein the web document is displayed in a web browser.

26. A system according to claim 23, wherein the web document is embedded in an e-mail.

27. A system according to claim 23, wherein the web document is embedded in a desktop application.
